(19) United States
(12) Patent Application Publication
(10) Pub. No.: US 2026/0097332 A1
(43) Pub. Date: Apr. 9, 2026

(54) REINFORCED V-BANK AIR FILTER

(71) Applicant: K&N Engineering, Inc., Corona, CA (US)

(72) Inventor: Steve Williams, Cherry Valley, CA (US)

(73) Assignee: K&N Engineering, Inc., Corona, CA (US)

(21) Appl. No.: 19/352,206

(22) Filed: Oct. 7, 2025

Related U.S. Application Data
(60) Provisional application No. 63/704,644, filed on Oct. 8, 2024.

(51) Int. Cl. B01D 29/07; F24F 8/108

(52) U.S. Cl. CPC B01D 29/07; F24F 8/108; B01D 2201/0415; B01D 2279/50

(57) ABSTRACT

An apparatus and methods are provided for a reinforced V-bank air filter to remove contaminants from air within interior building environments. The reinforced V-bank air filter includes a V-bank filter element comprising a relatively large filter medium that is routed around the outside of multiple pleat supports. The pleat supports are vertically disposed and distributed at intervals between a top end plate and a bottom end plate supporting the V-bank filter element. Side rails enable attaching opposite ends of the V-bank filter element to the V-bank air filter. Seats in the top and bottom end plates maintain V-configurations of the V-bank filter element. The pleat supports and side rails enable removing the V-bank filter element from the V-bank air filter for servicing. The V-bank filter element can be cleaned by using a water hose to flush contaminants from the filter element and then allowing the filter element to dry.

### PRIORITY

This application claims the benefit of and priority to U.S. Provisional Application, entitled “Reinforced V-Bank Air Filter,” filed on Oct. 8, 2024, and having application Ser. No. 63/704,644, the entirety of said application being incorporated herein by reference.

### FIELD

Embodiments of the present disclosure generally relate to the field of filter devices. More specifically, embodiments of the disclosure relate to an apparatus and methods for a reinforced V-bank air filter to remove airborne molecular contaminants and volatile organic compounds from air within interior building spaces.

### BACKGROUND

Heating, ventilation, and air conditioning (HVAC) systems generally operate to provide optimal indoor air quality to occupants within interior building spaces. HVAC systems achieve optimal indoor air quality by conditioning air, removing particle contaminants by way of ventilation and filtration of air, and providing proper building pressurization.

While there are many different HVAC system designs and operational approaches, and each building design is unique, HVAC systems generally share a few basic design elements. For example, outside air (“supply air”) generally is drawn into a HVAC system of a building through an air intake. Once in the HVAC system, the supply air is filtered to remove particle contaminants, then heated or cooled, and then circulated throughout the building by way of an air distribution system. Many air distribution systems comprise a return air system configured to draw air from interior building spaces and return the air (“return air”) to the HVAC system. The return air is then mixed with supply air and then filtered, conditioned, and circulated throughout the building. Often times, a portion of the air circulating within the building may be exhausted to the exterior of the building so as to maintain a desired barometric pressure within the building.

As will be appreciated, the effectiveness of the HVAC system to provide optimal indoor air quality depends largely on the ability of an air filter within the HVAC system to remove particle contaminants from the air within the building. A HVAC system air filter typically comprises fibrous materials configured to remove solid particulates, such as dust, pollen, mold, and bacteria from the air passing through the HVAC system. A drawback to conventional HVAC system air filters, however, is that highly effective air filters capable of removing very small contaminants, such as airborne molecular contaminants and volatile organic compounds (VOCs), tend to restrict airflow through the air filter, thereby making the HVAC system work harder and consume more energy.

Another drawback to conventional HVAC system air filters is that dirty or clogged air filters typically are removed from the HVAC system and discarded, and a new HVAC system air filter is then installed. Further, HVAC system air filters may be unnecessarily discarded and replaced in an effort to increase HVAC system airflow and thus decrease operation costs. Considering that there are millions of buildings with HVAC systems throughout the world, the volume of discarded air filters that could be eliminated from landfills is staggering.

What is needed, therefore, is an air filter that may be periodically cleaned and reused and is configured for removing airborne molecular contaminants and VOCs from air within interior building spaces without obstructing air flow through the air filter.

### SUMMARY

An apparatus and methods are provided for a reinforced V-bank air filter to remove contaminants from air within interior building environments. The reinforced V-bank air filter includes a V-bank filter element comprising a relatively large filter medium that is routed around the outside of multiple pleat supports. The pleat supports are vertically disposed and distributed at intervals between a top end plate and a bottom end plate supporting the V-bank filter element. Side rails enable attaching opposite ends of the V-bank filter element to the V-bank air filter. Seats in the top and bottom end plates maintain V-configurations of the V-bank filter element. The pleat supports and side rails enable removing the V-bank filter element from the V-bank air filter for servicing. The V-bank filter element can be cleaned by using a water hose to flush contaminants from the filter element and then allowing the filter element to dry.

In an exemplary embodiment, an apparatus for a reinforced V-bank air filter to clean air in interior building environments comprises: a multiplicity of vertically disposed pleat supports; a V-bank filter element comprising a relatively large filter medium routed around the outside of the pleat supports; a top end plate and a bottom end plate supporting the V-bank filter element; and side rails for attaching and retaining opposite ends of the V-bank filter element.

In another exemplary embodiment, the top end plate, the bottom end plate, the side rails, and the multiplicity of pleat supports are configured to provide structural rigidity to the reinforced V-bank air filter. In another exemplary embodiment, the top end plate, the bottom end plate, the side rails, and the multiplicity of pleat supports are configured to orient the air filter within an HVAC system such that a return airstream is directed through the V-bank filter element. In another exemplary embodiment, the top end plate, the bottom end plate, the side rails, and the multiplicity of pleat supports define openings that allow the return airstream to pass through the V-bank filter element.

In another exemplary embodiment, the top end plate and the bottom end plate each provide a ledge portion that has a shape and a size configured to support the air filter within an HVAC system. In another exemplary embodiment, the side rails each comprises a pleat support that includes a side ledge disposed between the top end plate and the bottom end plate. In another exemplary embodiment, the side rails and the ledge portions provide an uninterrupted ledge that is configured to orient the V-bank air filter within the HVAC system. In another exemplary embodiment, a gasket is incorporated into the uninterrupted ledge. In another exemplary embodiment, the gasket is incorporated directly into the uninterrupted ledge to eliminate a need for a separately provided gasket. In another exemplary embodiment, each of the ledge portions and the side rails includes a strip of material that operates as a gasket once the multi-panel air filter is assembled.

In another exemplary embodiment, supportive members are incorporated into one or more of the V-bank air filter and the V-bank filter element. In another exemplary embodiment, the supportive members comprise a grating disposed between the top end plate and the bottom end plate to provide additional support to the V-bank filter element. In another exemplary embodiment, the grating comprises a multiplicity of vertical wires or thin poles disposed between the top and bottom plates and distributed at intervals between the pleat supports. In another exemplary embodiment, the vertical wires are incorporated into the V-bank filter element and configured to mechanically engage with the top end plate and the bottom end plate. In another exemplary embodiment, the grating includes diagonally disposed members that provide additional support to the V-bank filter element. In another exemplary embodiment, the supportive members comprise one or more wire screens incorporated into the V-bank filter element to provide structural rigidity to the V-bank filter element.

In another exemplary embodiment, an upstream panel air filter is coupled with the V-bank air filter. In another exemplary embodiment, the panel air filter comprises a primary filter while the V-bank air filter comprises a secondary filter. In another exemplary embodiment, the primary filter has a lower MERV rating than the MERV rating of the secondary filter. In another exemplary embodiment, the primary filter is coupled with the secondary filter by way of a hinge and a clasp.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a cross-sectional view of an exemplary-use environment wherein a reinforced V-bank air filter is incorporated into a HVAC system of a building, according to the present disclosure;

FIG. 2 illustrates a schematic view of an exemplary embodiment of a HVAC system comprising a reinforced V-bank air filter in accordance with the present disclosure;

FIG. 3 illustrates a perspective view of an exemplary embodiment of a reinforced V-bank air filter that may be used to clean an airstream flowing through a HVAC system to clean air within interior building spaces;

FIG. 4 illustrates a cross-sectional view of the reinforced V-bank air filter of FIG. 3, taken along a line 4-4;

FIG. 5 illustrates an isometric exploded view of the reinforced V-bank air filter of FIG. 3, according to the present disclosure; and

FIG. 6 illustrates a cross-sectional view of an exemplary embodiment of a reinforced V-bank air filter that is coupled with an upstream, primary air filter, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the reinforced V-bank air filter and methods disclosed herein may be practiced without these specific details. In other instances, specific numeric references such as “first filter,” may be made. However, the specific numeric reference should not be interpreted as a literal sequential order but rather interpreted that the “first filter” is different than a “second filter. ” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, HVAC systems operate to provide optimal indoor air quality to occupants within interior building spaces. HVAC systems achieve optimal indoor air quality by conditioning air, removing particle contaminants by way of ventilation and filtration of air, and providing proper building pressurization. The effectiveness of an HVAC system to provide optimal indoor air quality depends largely on the ability of an air filter within the HVAC system to remove particle contaminants from the air within the building. A drawback to many conventional HVAC system air filters, however, is that highly effective air filters capable of removing very small contaminants tend to restrict airflow through the air filter, thereby making the HVAC system work harder and consume more energy. Another drawback to conventional HVAC system air filters is that dirty or clogged air filters typically must be removed from the HVAC system and discarded, sometimes prematurely, before a new HVAC system air filter can be installed. Embodiments presented herein provide a cleanable, reinforced V-bank air filter configured to remove airborne molecular contaminants and VOCs from air within interior building spaces.

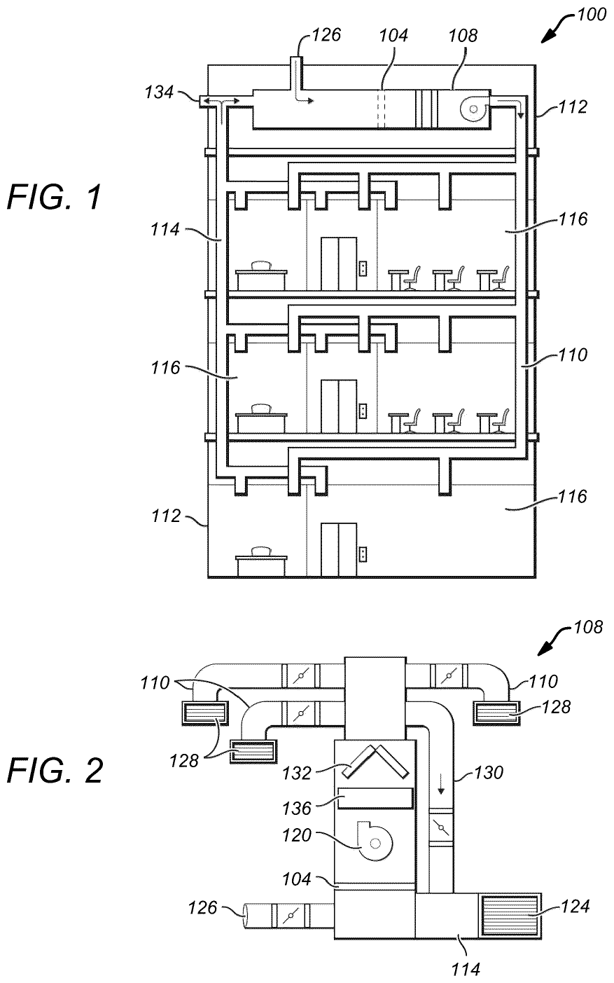

FIG. 1 illustrates an exemplary-use environment 100 wherein an air filter 104 is incorporated into a HVAC system 108 of a building 112 to clean an airstream drawn through the air filter 104. Although the building 112 illustrated in FIG. 1 comprises a multi-story office building, it should be understood that the building 112 may comprise any of various structures, such as warehouses, storage spaces, server rooms, clean rooms, office spaces, residential homes, apartments, condominiums, and the like, without limitation. After passing through the air filter 104, the airstream is routed into one or more building spaces 116 by way of a supply ductwork 110. Air within the building spaces 116 is routed back to the HVAC system 108 by way of a return ductwork 114. It will be appreciated that the building 112 may comprise multiple stories, each of which stores including one or more building spaces 116, as illustrated in FIG. 1, or may comprise a single-story building, including but not limited to a detached residential home.

FIG. 2 illustrates a schematic view of an exemplary embodiment of a HVAC system 108 that may be used to clean air within building spaces 116. The HVAC system 108 generally comprises a fan 120 configured to draw a return airstream 124 from the building spaces 116 through the air filter 104 whereby airborne molecular contaminants, VOCs, and other particle contaminants are removed from the airstream. Particle contaminants removed from the return airstream 124 are entrapped in the air filter 104. The fan 120 then pushes a clean airstream 128 through an air conditioning system 132 and a heater core 136 and then into the building spaces 116. As will be appreciated, the air conditioning system 132 and the heater core 136 facilitate providing a consistent, comfortable temperature within the building spaces 116 by respectively cooling and heating the clean airstream 128, as needed. As further shown in FIG. 2, the return airstream 124 may be combined with an outside airstream 126, as well as with a bypass airstream 130 airstream so as to maintain a desired barometric pressure within the HVAC system 108 and within the building spaces 116. In some embodiments, an exhaust airstream 134 (see FIG. 1) may be further incorporated into the HVAC system 108 to maintain the desired barometric pressure and to allow entry of the outside airstream 126.

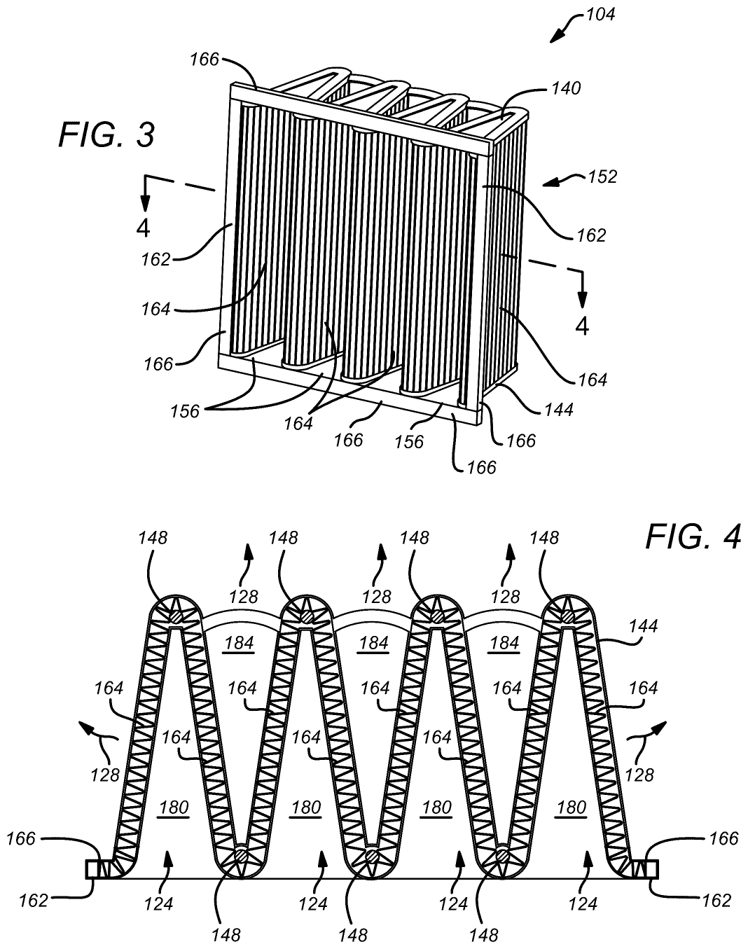

FIG. 3 illustrates an exemplary embodiment of a reinforced V-bank air filter 104 according to the present disclosure. The reinforced V-bank air filter 104 (hereinafter, “air filter 104”) generally is a V-bank variety of air filter, which comprises a class of filters also referred to as rigid pocket filters. V-bank filters often comprise an important element in clean room environments. V-bank filters may be implemented as pre-filters before HEPA filters, for example. The ‘V’ configuration provides more surface area than traditional filters, reduces an overall pressure drop in the HVAC system 108, and extends the usable life of downstream filters.

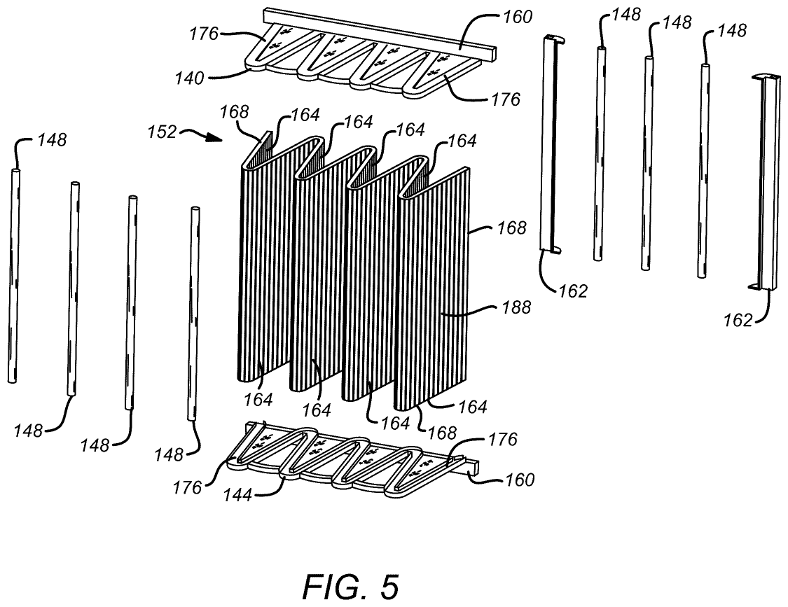

As shown in FIG. 3, the air filter 104 broadly comprises a top end plate 140, a bottom end plate 144, and multiple pleat supports 148 (see FIGS. 4-6) disposed vertically between the top and bottom end plates 140, 144. The top and bottom end plates 140, 144 and the pleat supports 148 support a V-bank filter element 152 and provide structural rigidity to the air filter 104. The top and bottom end plates 140, 144 and the pleat supports 148 are configured to orient the air filter 104 within the HVAC system 108 such that the return airstream 124 is directed through the V-bank filter element 152. As such, the top and bottom end plates 140, 144 and the pleat supports 148 define openings 156 that allow the return airstream 124 to pass through the V-bank filter element 152. In some embodiments, such as the embodiment shown in FIG. 5, the top and bottom end plates 140, 144 each provide a ledge portion 160 that has a shape and a size configured to support the air filter 104 within the HVAC system 108.

Moreover, in the illustrated embodiment shown in FIG. 5, a pleat support that includes a side ledge (hereinafter, “side rail 162”) is disposed between the end plates 140, 144 along opposite sides of the air filter 104. The side rails 162 and the ledge portions 160 disposed on the top and bottom end plates 140, 144 provide an uninterrupted ledge 166 that extends around the openings 156, as shown in FIG. 3. The uninterrupted ledge 166 is configured to orient the air filter 104 within the HVAC system 108. As such, the top and bottom end plates 140, 144, the pleat supports 148, and the side rails 162 may be formed of any rigid material capable of supporting the air filter 104 within the HVAC system 108. It should be understood that the dimensions of the uninterrupted ledge 166 may be varied to accommodate the make and model of the HVAC system 108 for which the air filter 104 is intended to be used.

As mentioned above, the top and bottom end plates 140, 144 and the pleat supports 148 support the V-bank filter element 152 and provide structural rigidity to the air filter 104. In some embodiments, however, additional supportive members may be incorporated into the air filter 104 and/or the V-bank filter element 152. For example, in some embodiments, a grating can be disposed between the top and bottom end plates 140, 144 to provide additional support to the V-bank filter element 152. The grating can comprise, in some embodiments, a multiplicity of vertical wires or thin poles disposed between the top and bottom plates 140, 144 and distributed at intervals between the pleat supports 148. It is contemplated that the vertical wires or thin poles can provide additional support the portions of the V-bank filter element 152 between the pleat supports 148. In some embodiments, the vertical wires can be incorporated into the V-bank filter element 152 and configured to mechanically engage with the top and bottom end plates 140, 144. In some embodiments, however, the grating can include diagonally disposed members, such as strips of rigid material, that provide additional support to the V-bank filter element 152. Furthermore, as described herein, in some embodiments, one or more wire screens can be incorporated into the V-bank filter element 152 to provide structural rigidity to the air filter 104 and the V-bank filter element 152.

In some embodiments, a gasket may be incorporated into the air filter 104 to prevent the return airstream 124 from flowing around the uninterrupted ledge 166 and thus bypassing the V-bank filter element 152. For example, in some embodiments, a gasket may be configured to be disposed between the uninterrupted ledge 166 and an interior of the HVAC system 108. In some embodiments, the gasket may be incorporated directly into the uninterrupted ledge 166 to eliminate a need for a separately provided gasket. Thus, the ledge portions 160 of the top and bottom end plates 140, 144, and the side rails 162 may each include a strip of material that can operate as a gasket once the air filter 104 is assembled as shown in FIG. 3. As will be appreciated, the strips can be disposed on the ledge portions 160 and the side rail 162 such that the strips form a continuous strip of gasket material that extends around the uninterrupted ledge 166 once the air filter 104 is assembled. It is contemplated that the strips of gasket material may comprise any material that is amenable to providing an airtight seal between the uninterrupted ledge 166 and the interior of the HVAC system 108, without limitation.

In general, the V-bank filter element 152 comprises a relatively large filter medium that is routed around the outside of the pleat supports 148 and attached at opposite ends to the side rails 162. The pleat supports 148 arrange the V-bank filter element 152 into a series of two or more filter portions 164 that are angled with respect to one another to form one or more ‘V’-configurations. Further, each of the top and bottom end plates 140, 144 includes a seat 176 (see FIG. 5) that receives respective top and bottom edges of the filter panels 164, such that the filter portions 164 are retained in the V-configurations shown in FIG. 4. The V-configurations may be viewed as defining upstream and downstream volumes. For example, each of the openings 156 allows the return airstream 124 to enter an upstream volume 180 between adjacent V-configurations of the filter panels 164. Upon passing through the filter panels 164, a clean airstream 128 exits the air filter 104 through a downstream volume 184 disposed between adjacent V-configurations of the filter panels 164.

Moreover, the seats 176 are configured to fixate the V-configurations of the filter portions 164 such that the upstream volumes 180 between adjacent V-configurations include substantially identical angles and areas. As such, the upstream volumes 180 are substantially identical to one another. Similarly, the seats 176 are configured such that the downstream volumes 184 between adjacent V-configurations include substantially identical angles and areas, and thus the downstream volumes 184 are substantially identical to one another. It is contemplated that the top and bottom end plates 140, 144 may be formed of any rigid material suitable for maintaining the configuration of the seats 176 and thus preserving the V-configurations of the filter portions 164 shown in FIG. 4.

It is contemplated that the ends of the V-bank filter element 152 can be coupled with the side rails 162 by way of any of various devices, mechanisms, or fasteners, without limitation. For example, in an embodiment, the ends of the V-bank filter element 152 can include a rigid strip configured to engage with a series of clasps (not shown) disposed along each side rail 162. It is further contemplated that the ends of the V-bank filter element 152 are detachable from the side rails 162. Other specific embodiments whereby the ends of the V-bank filter element 152 can be coupled with the side rails 162 will be apparent to those skilled in the art. Thus, a damaged or prematurely dirty filter element 152 can be removed from the air filter 104 and replaced with a new filter element 152 or a previously cleaned filter element 152 without removing the air filter 104 from the HVAC system 108. In some embodiments, a clean filter element 152 can be installed into the air filter 104 immediately after removing the dirty filter element 152, thereby maintaining filtration of the return airstream 124 during the time while the dirty filter element 152 is being cleaned and dried for reuse in the HVAC system 108.

Turning, now, to FIG. 5, the V-bank filter element 152 comprises a filter medium 188 that provides an area through which to pass the return airstream 124 and entrap particulates and other contaminates flowing with the airstream 124. The filter medium 188 may be formed of paper, foam, cotton, spun fiberglass, or other known filter materials, woven or non-woven material, synthetic or natural, or any combination thereof. The filter medium 188 may be pleated, or otherwise shaped, or contoured so as to increase the surface area for passing the return airstream 124 to be cleaned. In the illustrated embodiment, the filter medium 188 is vertically pleated to facilitate wrapping the filter element 152 around the pleat supports 148. Thus, the effective length of the filter medium 188 is greater than the length of the filter element 152 generally, due to the pleats, such that the surface area of the filter medium 188 is greater than the surface area of the filter element 152.

In some embodiments, the V-bank filter element 152 includes an edge portion 168 configured to be received by the seats 176. Preferably, edge portion 168 comprises a material that is amenable to being folded around the pleat supports 148, as shown in FIG. 4. Any of a variety of mechanisms (not shown) may be used to affix the edge portion 168 to the filter medium 188. In some embodiments, the edge portion 168 may be molded onto a wire support comprising the filter medium 188. In some embodiments, the edge portion 168 may include a recess that receives a perimeter of the filter medium 188. Further, in some embodiments, the edge portion 168 may include a strip that is crimped such that it folds onto and retains the wire support and the filter medium 188. As will be appreciated, the edge portion 168 is configured to be retained in the seats 176 such that the return airstream 124 flows through the filter medium 188 rather than leaking around the edge portion 168.

In some embodiments, the filter medium 188 may be a composite filter medium comprising one or more media layers, each having unique filtration properties such that the combination of media layers exhibits a relatively high filtration efficiency and a relatively low air pressure drop across the filter medium 188. For example, in one embodiment, the filter medium 188 may comprise a first media layer and a second media layer. The first media layer may comprise a fiber density that is relatively lower than the fiber density of the second media layer. Thus, the filter medium 188 may comprise a fiber density that generally increases in the direction of air flow through the filter medium 188.

In some embodiments, the filter medium 188 may comprise a dried synthetic material that generally becomes surface loaded as contaminants are deposited onto upstream surfaces of the filter medium 188 during use of the air filter 104 in the HVAC system 108. As will be appreciated, the dried synthetic material may be cleaned by simply using a water hose to flush the contaminants from the filter medium 188. In some embodiments, the filter medium 188 may be cleaned by applying the water to downstream surfaces of the filter medium 188 to dislodge the contaminants from the upstream surfaces of the filter medium 188. In some embodiments, however, the filter medium 188 may be cleaned by applying higher-pressure water to the upstream surfaces of the filter medium 188 to flush the contaminants away from the filter medium 188.

It is contemplated that a practitioner may periodically clean the filter medium 188 rather than replacing the entire air filter 104, as is typically done with conventional air filter systems. As described herein, it is envisioned that the air filter 104 can be serviced by removing V-bank filter element 152 from the air filter 104 without having to remove the entire air filter 104 from the HVAC system 108. The V-bank filter element 152 can be cleaned by using a water hose to flush contaminants from the filter medium 188 and then allowing the filter medium 188 to dry. A new or previously cleaned filter element 152 can be installed into the air filter 104 immediately after removing the dirty filter element 152 so as to maintain filtration of the return airstream 124 during cleaning and drying the dirty filter element 152. In some embodiments, however, the entire air filter 104 can be removed from the HVAC system 108 to enable removing any trapped debris from the HVAC system 108.

In some embodiments, wherein the filter medium 188 is configured to include a filter oil composition, a solvent may be used to remove the filter oil from the filter medium 188. Once the filter medium 188 has dried, a suitably formulated filter oil composition can be applied and allowed to wick into the filter medium 188. The clean, freshly oiled filter medium 188 can then be routed around the pleat supports 148 and fastened to the side rails 162, as described herein. In some embodiments, wherein the air filter 104 is removed from the HVAC system 108, the filter medium 188 can be installed into the air filter 104 before reinstalling the air filter 104 into the HVAC system 108. Various other cleaning methods will be apparent to those skilled in the art without deviating from the spirit and scope of the present disclosure.

In some embodiments, wherein the filter medium 188 comprises the filter oil composition, the filter medium 188 may comprise at least a cotton gauze portion including 4 to 6 layers of cotton gauze disposed between two epoxy-coated aluminum wire screens. In some embodiments, the wire screens may be comprised of nylon, or other suitable thermoplastic material. The cotton may be advantageously treated with the above-mentioned filter oil composition so as to cause tackiness throughout microscopic strands comprising the filter medium 188. The nature of the cotton allows high volumes of airflow, and when combined with the tackiness of the filter oil composition creates a powerful filtering medium which ensures a high degree of air filtration.

During operation of the HVAC system 108, contaminant particles cling to the fibers within the volume of the filter medium 188 and become part of the filtering medium 188, a process referred to as “depth loading.” It will be appreciated that depth loading allows the air filter 104 to capture and retain significantly more contaminants per unit of area than conventional air filters. Contaminant particles are stopped by the layers of cotton gauze and held in suspension by the filter oil composition, and thus the contaminants collected on the surface of the filter medium 188 have little effect on air flow during much of the service life of the air filter 104. Moreover, as the filter medium 188 collects an increasing volume of contaminants and debris, an additional degree of filtering action begins to take place as the return airstream 124 first passes through the trapped contaminants on the surface of the filter medium 188 before passing through deeper layers within the filter medium 188. In essence, the trapped contaminants begin to operate as an additional filter material which precedes the filter medium 188. Thus, the air filter 104 continues to exhibit a high degree of air flow and filtration throughout the service life of the filter, thereby reducing operating costs of the HVAC system 108.

As will be appreciated, treating the filter medium 188 with the filter oil composition generally enables the filter medium 188 to capture contaminants by way of interception, whereby contaminants, such as dirt particles, traveling with the return airstream 124 directly contact the fibers comprising the filter medium 188 and are then held in place by the filter oil composition. Larger or heavier particles generally are captured by way of impaction, whereby inertia or momentum of the particles causes them to deviate from the path of the return airstream 124 through the filter medium 188, and instead the particles run straight into the fibers and are captured by the filter oil composition.

Particle contaminants having very small sizes may be captured by way of diffusion. As will be appreciated, small particles are highly affected by forces within the return airstream 124 through the filter medium 188. Forces due to velocity changes, pressure changes, and turbulence caused by other particles, as well as interaction with air molecules, generally causes the small particles to follow random, chaotic flow paths through the filter medium 188. Consequently, the small particles do not follow the return airstream 124, and their erratic motion causes them to collide with the fibers comprising the filter medium 188 and remain captured by the filter oil composition. Diffusion and the filter oil composition enable the air filter 104 to capture particle contaminants having sizes that are much smaller than the openings between the fibers comprising the filter medium 188. Furthermore, the filter oil composition enables the air filter 104 to capture contaminants throughout the volume of the filter medium 188, rather than only on the surface of the filter as is common with conventional air filters. The multiple layers of cotton fibers comprising the filter medium 188 coupled with the tackiness provided by the filter oil composition provide many levels of contaminant retention, thereby enabling the air filter 104 to hold significantly more contaminants per unit of area of the filter medium 188 than is possible with conventional air filters.

In some embodiments, the layers of cotton gauze treated with the filter oil composition may be coupled with portions of the filter medium 188 wherein other filtration mechanisms are used, thereby forming a composite filter medium 188 capable of removing airborne molecular contaminants and VOCs from the return airstream 124. For example, in some embodiments, the composite filter medium 188 may be comprised of a cotton gauze portion, as described herein, and an electrostatic portion. In such embodiments, the electrostatic portion of the composite filter medium 188 may be disposed downstream of the cotton gauze portion and configured to utilize electrostatic attraction and agglomeration to entrap particle contaminants. Thus, particle contaminants that would otherwise avoid directly colliding with fibers comprising the cotton gauze may be electrostatically captured and entrapped within the filter medium 188.

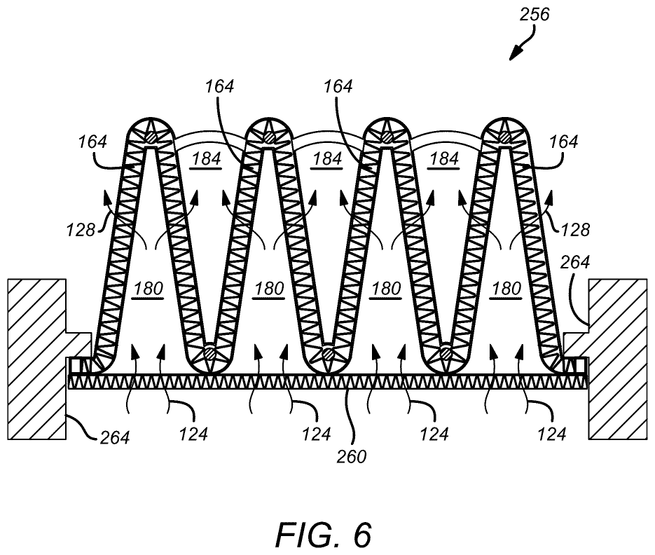

Turning, now, to FIG. 6, a cross-sectional view of an exemplary embodiment of an air filter 256 is shown coupled with an upstream, panel air filter 260, according to the present disclosure. The air filter 256 shown in FIG. 6 is substantially identical to the air filter 104 shown in FIGS. 3-5. In the embodiment illustrated in FIG. 6, a return airstream 124 flows through the panel air filter 260 before entering upstream volumes 180 of the air filter 256. As such, upon the return airstream 124 passing through filter portions 164 comprising the air filter 256, a clean airstream 128 exits the air filter 256 through downstream volumes 184 of the air filter 256.

In the embodiment illustrated in FIG. 6, the return airstream 124 flows through the panel air filter 260 before passing through the air filter 256. As such, the panel air filter 260 comprises a primary filter 260 while the air filter 256 comprises a secondary filter 256. It is contemplated that primary filter 260 can be used to remove a relatively large portion of the contaminants and VOCs flowing with the return airstream 124 so as to extend the longevity of the secondary filter 256. In some embodiments, the primary filter 260 may have a lower MERV rating than the MERV rating of the secondary filter 256. Since the cost of air filters is generally proportional to their MERV ratings, it is cost effective to replace or service the primary filter 260 more frequently than the secondary filter 256. In some embodiments, wherein the filters 256, 260 are configured to be reused, the primary filter 260 can be removed from the HVAC system 108 and cleaned with greater ease than removing and cleaning the secondary filter 256. As such, including the primary filter 260 discourages practitioners from putting off timely service intervals due to a perceived complexity of servicing the secondary filter 256.

As shown in FIG. 6, the filters 256, 260 are supported by way of structures 264. It should be understood that structures 264 comprise portions disposed in the HVAC system 108 that are configured to support at least the secondary filter 256. In some embodiments, therefore, the primary filter 260 can be incorporated into the secondary filter 256. Thus, the primary filter 260 can be a removable portion of the secondary filter 256. For example, the primary filter 260 may be coupled with the secondary filter 256 by way of a hinge and a clasp (not shown). In such embodiments, the primary filter 260 may be removed from the second filter 256 by unfastening the clasp and then rotating the primary filter 260 away from the secondary filter 256 in a manner that resembles opening a door. Thus, the primary filter 260 may be uninstalled from the secondary filter 256 without the entire secondary filter 256 having to be removed from the structures 264. As such, the primary filter 260 can be easily removed, cleaned, and reinstalled into the HVAC system 108 to preserve the operating efficiency of the HVAC system 108.

In some embodiments, wherein the primary filter 260 includes a filter oil composition, a solvent may be used to remove the filter oil during cleaning the primary filter 260. After allowing the primary filter 260 to dry, a suitably formulated filter oil composition can be applied and allowed to wick into the primary filter 260. The primary filter 260 can then be reinstalled into secondary filter 256 within the HVAC system 108. Various other cleaning methods will be apparent to those skilled in the art without deviating from the spirit and scope of the present disclosure.

In some embodiments, either or both of the filters 256, 260 may be configured to detect a pressure differential across the filter, due to contaminant buildup, and indicate when the filter needs to be serviced. For example, in some embodiments, the primary filter 260 can include a filter medium supported within a frame and a differential pressure detector incorporated into the frame. The differential pressure detector can signal when the pressure differential across the primary filter 260 reaches a threshold value due to contaminant buildup within the filter medium. The differential pressure detector can include circuitry that wirelessly signals an application stored on a mobile device to display a notification when the primary filter 260 needs to be cleaned or replaced to minimize energy consumption by the HVAC system 108. Further details pertaining to incorporating differential pressure detectors into air filters may be found in U.S. Provisional Application, entitled “Air Filter System For Detecting A Pressure Differential To Indicate A Need For Servicing,” filed on Dec. 12, 2023, and having application Ser. No. 63/609,110, the entirety of which application is incorporated herein by reference and made a part of the present disclosure.

In some embodiments, either or both of the filters 256, 260 may be configured to detect mechanical strain on the filter, due to contaminant buildup, and indicate when the filter needs to be serviced. In one embodiment, for example, the primary filter 260 comprises a filter medium supported within a frame and a mechanical strain detector incorporated into the frame. The mechanical strain detector signals when the force acting on the primary filter 260 reaches a threshold value due to contaminant buildup within the filter medium. The mechanical strain detector includes circuitry that wirelessly signals an application stored on a mobile device to display a notification when the primary filter 260 needs to be cleaned or replaced to minimize energy consumption by the HVAC system 108. Further details pertaining to air filters configured to detect mechanical strain can be found in U.S. Provisional Application, entitled “Air Filter System For Detecting Mechanical Strain To Indicate A Need For Servicing,” filed on Dec. 12, 2023, and having application Ser. No. 63/609,280, the entirety of which application is incorporated herein by reference and made a part of the present disclosure.

In some embodiments, either or both of the filters 256, 260 may be configured to detect a temperature differential across the filter, due to contaminant buildup, and indicate when the filter needs to be serviced. In an exemplary embodiment, the primary filter 260 comprises a filter medium supported within a frame and a differential temperature sensor incorporated into the frame. The differential temperature sensor signals when air pressure across the air filter reaches a threshold value due to contaminant buildup within the filter medium. The differential temperature sensor includes circuitry that wirelessly signals an application stored on a mobile device to display a notification when the primary filter 260 needs to be cleaned or replaced to minimize energy consumption by the HVAC system 108. Further details pertaining to air filters configured to detect a temperature differential can be found in U.S. Provisional Application, entitled “Air Filter System For Detecting A Temperature Differential To Indicate A Need For Servicing,” filed on Dec. 12, 2023, and having application Ser. No. 63/609,285, the entirety of which application is incorporated herein by reference and made a part of the present disclosure.

In some embodiments, either or both of the filters 256, 260 may be configured to detect changes in electrical properties of electrodes in the filter and determine a corresponding pressure differential across the filter, due to contaminant buildup, to indicate when the filter needs to be serviced. In some embodiments, the primary filter 260 can include a filter medium supported within a frame and a differential electrical properties detector incorporated into the frame. The differential electrical properties detector can signal when air pressure across the primary filter 260 reaches a threshold value due to contaminant buildup within the filter medium. The differential electrical properties detector can include circuitry that wirelessly signals an application stored on a mobile device to display a notification when the primary filter 260 needs to be cleaned or replaced to minimize energy consumption by the HVAC system 108. Further details pertaining to air filters configured to detect differential electrical properties can be found in U.S. Provisional Application, entitled “Air Filter System For Detecting Differential Electrical Properties To Indicate A Need For Servicing,” filed on Dec. 14, 2023, and having application Ser. No. 63/610,029, the entirety of which application is incorporated herein by reference and made a part of the present disclosure.

In some embodiments, either or both of the filters 256, 260 may be configured to detect changes in optical properties of the filter and determine a corresponding pressure differential across the filter, due to contaminant buildup, to indicate when the filter needs to be serviced. For example, in some embodiments, primary filter 260 comprises a filter medium supported within a frame and a differential optical properties detector incorporated into the frame. The differential optical properties detector signals when air pressure across the primary filter 260 reaches a threshold value due to contaminant buildup within the filter medium. The differential optical properties detector includes circuitry that wirelessly signals an application stored on a mobile device to display a notification when the primary filter 260 needs to be cleaned or replaced to minimize energy consumption by the HVAC system 108. Further details pertaining to air filters configured to detect differential optical properties can be found in U.S. Provisional Application, entitled “Air Filter System For Detecting Differential Optical Properties To Indicate A Need For Servicing,” filed on Dec. 14, 2023, and having application Ser. No. 63/610,076, the entirety of which application is incorporated herein by reference and made a part of the present disclosure.

In some embodiments, either or both of the filters 256, 260 may be configured to detect passive vibrations of the filter, due to contaminant buildup, and indicate when the filter needs to be serviced. For example, in some embodiments, the primary filter 260 may comprise a filter medium supported within a frame and a resonant characteristics detector incorporated into the frame. The resonant characteristics detector may be configured to signal when the force acting on the primary filter 260 reaches a threshold value due to contaminant buildup within the filter medium. The resonant characteristics detector may include circuitry that wirelessly signals an application stored on a mobile device to display a notification when the primary filter 260 needs to be cleaned or replaced to minimize energy consumption by the HVAC system 108. Further details pertaining to air filters configured to detect air filter vibration differences can be found in U.S. Provisional Application, entitled “Air Filter Vibration Differences To Indicate Contaminant Buildup,” filed on Dec. 14, 2023, and having application Ser. No. 63/610,056, the entirety of which application is incorporated herein by reference and made a part of the present disclosure.

While the reinforced V-bank air filter and methods have been described in terms of particular variations and illustrative figures, those of ordinary skill in the art will recognize that the reinforced V-bank air filter is not limited to the variations or figures described. In addition, where methods and steps described above indicate certain events occurring in certain order, those of ordinary skill in the art will recognize that the ordering of certain steps may be modified and that such modifications are in accordance with the variations of the reinforced V-bank air filter. Additionally, certain of the steps may be performed concurrently in a parallel process, when possible, as well as performed sequentially as described above. To the extent there are variations of the reinforced V-bank air filter, which are within the spirit of the disclosure or equivalent to the reinforced V-bank air filter found in the claims, it is the intent that this patent will cover those variations as well. Therefore, the present disclosure is to be understood as not limited by the specific embodiments described herein, but only by scope of the appended claims.

What is claimed is:

1. An apparatus for a reinforced V-bank air filter to clean air in interior building environments, comprising:
a multiplicity of vertically disposed pleat supports;
a V-bank filter element comprising a relatively large filter medium routed around the outside of the pleat supports;
a top end plate and a bottom end plate supporting the V-bank filter element; and
side rails for attaching and retaining opposite ends of the V-bank filter element.

2. The apparatus of claim 1, wherein the top end plate, the bottom end plate, the side rails, and the multiplicity of pleat supports are configured to provide structural rigidity to the reinforced V-bank air filter.

3. The apparatus of claim 2, wherein the top end plate, the bottom end plate, the side rails, and the multiplicity of pleat supports are configured to orient the air filter within an HVAC system such that a return airstream is directed through the V-bank filter element.

4. The apparatus of claim 2, wherein the top end plate, the bottom end plate, the side rails, and the multiplicity of pleat supports define openings that allow the return airstream to pass through the V-bank filter element.

5. The apparatus of claim 1, wherein the top end plate and the bottom end plate each provide a ledge portion that has a shape and a size configured to support the air filter within an HVAC system.

6. The apparatus of claim 5, wherein the side rails each comprises a pleat support that includes a side ledge disposed between the top end plate and the bottom end plate.

7. The apparatus of claim 6, wherein the side rails and the ledge portions provide an uninterrupted ledge that is configured to orient the V-bank air filter within the HVAC system.

8. The apparatus of claim 7, wherein a gasket is incorporated into the uninterrupted ledge.

9. The apparatus of claim 8, wherein the gasket is incorporated directly into the uninterrupted ledge to eliminate a need for a separately provided gasket.

10. The apparatus of claim 9, wherein each of the ledge portions and the side rails includes a strip of material that operates as a gasket once the multi-panel air filter is assembled.

11. The apparatus of claim 1, wherein supportive members are incorporated into one or more of the V-bank air filter and the V-bank filter element.

12. The apparatus of claim 11, wherein the supportive members comprise a grating disposed between the top end plate and the bottom end plate to provide additional support to the V-bank filter element.

13. The apparatus of claim 12, wherein the grating comprises a multiplicity of vertical wires or thin poles disposed between the top and bottom plates and distributed at intervals between the pleat supports.

14. The apparatus of claim 13, wherein the vertical wires are incorporated into the V-bank filter element and configured to mechanically engage with the top end plate and the bottom end plate.

15. The apparatus of claim 14, wherein the grating includes diagonally disposed members that provide additional support to the V-bank filter element.

16. The apparatus of claim 15, wherein the supportive members comprise one or more wire screens incorporated into the V-bank filter element to provide structural rigidity to the V-bank filter element.

17. The apparatus of claim 1, wherein an upstream panel air filter is coupled with the V-bank air filter.

18. The apparatus of claim 17, wherein the panel air filter comprises a primary filter while the V-bank air filter comprises a secondary filter.

19. The apparatus of claim 18, wherein the primary filter has a lower MERV rating than the MERV rating of the secondary filter.

20. The apparatus of claim 19, wherein the primary filter is coupled with the secondary filter by way of a hinge and a clasp.
